(19) United States
(12) Patent Application Publication
(10) Pub. No.: US 2012/0040099 A1
(43) Pub. Date: Feb. 16, 2012

(54) SOL AND METHOD FOR PRODUCING A DELAFOSSITE MIXED OXIDE LAYER STRUCTURE ON A SUBSTRATE AND ALSO A SUBSTRATE COATED WITH A MIXED OXIDE

(75) Inventors: Stefan Götzendörfer, Gerbrunn (DE); Peer Löbmann, Gerbrunn (DE); Martina Kapuschinski, Wurzburg (DE)

(73) Assignee: Fraunhofer-Gesellschaft Zur Förderung Der Angewandten Forschung E.V., München (DE)

(21) Appl. No.: 13/003,142

(22) PCT Filed: Jul. 6, 2009
(86) PCT No.: PCT/EP2009/004878

§ 371 Date: May 23, 2011

(30) Foreign Application Priority Data
Jul. 8, 2008 (DE) 10 2008 032 127.3

(51) Int. Cl. B05D 7/24; B05D 3/02; C03C 17/23; C09D 1/00

(52) U.S. Cl. 427/343; 106/287.18; 106/287.17; 427/372.2

(57) ABSTRACT

The present invention relates to a sedimentation-stable sol which, in addition to a copper(II) salt, also comprises at least one further metallic salt, an additive which is contained ensuring that the metallic salts contained in the sol remain dissolved or in dispersion. Furthermore, the sol is suitable in the method according to the invention for producing a metallic mixed oxide layer on a substrate, the metallic mixed oxide layer having a delafossite structure. Likewise, a substrate which has a metallic mixed oxide layer with a delafossite structure and also possibilities of use thereof are indicated according to the invention.

The present invention relates to a sedimentation-stable sol which, in addition to a copper(II) salt, also comprises at least one further metallic salt, an additive which is contained ensuring that the metallic salts contained in the sol remain dissolved or in dispersion. Furthermore, the sol is suitable in the method according to the invention for producing a metallic mixed oxide layer on a substrate, the metallic mixed oxide layer having a delafossite structure. Likewise, a substrate which has a metallic mixed oxide layer with a delafossite structure and also possibilities of use thereof are indicated according to the invention.

Crystalline mixed oxides with a delafossite structure could be used as transparent p-conductive layers or thermoelectric materials.

To date, publications relating to wet chemical deposition of delafossite layers have been restricted to two representatives of these oxides, namely CuAlO₂ and CuYO₂. In the case of K. Tonooka, K. Simokawa, O. Nishimura, Thin Solid Films 2002, 411, 129-133, sintering temperatures of at least 1,050° C. are required however for the CuAlO₂ layer production so that only oxidised silicon substrates can be coated. M. Ohashi, Y. Lida, H. Morikawa, J. Am. Ceram. Soc. 2002, 85, 270-272 use on the other hand a multistage furnace process with drying in air at 110° C., heating to 400° C. in air and finally sintering at 800° C. to 900° C. under a continuous nitrogen flow. Therefore, this process is also suitable for coating silica glass. According to N. Tsuboi, K. Tosaka, S. Kobayashi, K. Kato, F. Kaneko, Jpn. J. Appl. Phys. 2008, 47, 588, this is successful likewise with CuYO2, the process being composed of a drying step at 95° C., heating in air to 550° C. and a sintering step up to 800 to 1,050° C. in air initially and finally under controlled nitrogen flow.

Furthermore, there are also further publications for producing sols for delafossite production (Z. Deng, X. Zhu, R. Tao, W. Dong, X. Fang, Mater. Lett. 2007, 61, 686-689; D. Li, X. Fang, Z. Deng, S. Zhou, R. Tao, W. Dong, T. Wang, Y. Zhao, G. Meng, X. Zhu, J. Phys. D: Appl. Phys. 2007, 40, 4910-4915; M. Snure, A. Tiwari, Appl. Phys. Lett. 2007, 91, 092123), however no wet coating with the sols is implemented in these cases. Instead, they are restricted to powder or target production and subsequently sintered, only very heterogeneous delafossite layers however being achievable.

The requirement exists therefore for developing a method for producing such layers with the general formula CuAO₂ (A stands for a trivalent cation) via the sol-gel method.

It was therefore the object of the present invention to provide a sol which is sedimentation-stable in its composition and is suitable for producing metallic mixed oxide layers with a delafossite structure. It is likewise the object of the present invention to make possible an advantageous method for producing metallic mixed oxides with a delafossite structure on substrates and also to indicate substrates coated in this manner.

This object is achieved, with respect to the sol, with the features of patent claim 1, with respect to the method for producing a mixed oxide layer with a delafossite structure on a substrate, with the features of patent claim 8 and also, with respect to the substrate coated with a mixed oxide layer with a delafossite structure, with the features of patent claim 13. Possibilities for use of such a substrate are indicated by patent claim 15. The respective dependent patent claims thereby represent advantageous developments.

According to the invention, a sol is hence provided, comprising a phase dispersed in at least one dispersion medium, which comprises
a) at least one Cu(II) salt,
b) at least one salt selected from the group consisting of Al(III) salts, Cr(III) salts, Fe(II) salts, Fe(III) salts, Co(II) salts, Co(III) salts, Y(III) salts, La(III) salts, Pr(III) salts, Nd(III) salts, Sm(III) salts, Eu(III) salts, Gd(III) salts, Tb(III) salts, Dy(III) salts, Ho(III) salts, Er(III) salts, Tm(III) salts and/or Yb(III) salts and also
c) at least one additive selected from the group consisting of hydroxycarboxylic acids, with 2 to 12 carbon atoms, alkoxycarboxylic acids with 2 to 12 carbon atoms, alkyl alcohols with 1 to 10 carbon atoms and at least two hydroxy groups and/or organic amines,
   the dispersion medium being selected from the group consisting of at least monovalent linear or branched alkyl alcohols with 1 to 6 carbon atoms.

Astonishingly, it was found that, by combining the additives mentioned under feature c) with the selected dispersion media, particularly sedimentation-stable sols can be produced which can still be processed and applied well even after a fairly long standing time. The additive thereby fulfils the object of stabilising the participating metallic cations in solution and of increasing the solubility of the products. The sols according to the invention are long-term stable (stability over several months) and can be used for dip coating of substrates. As a result, great material flexibility of the composition is achieved. It is likewise advantageous that the composition can be processed surprisingly at lower temperatures than known from the state of the art.

It is preferred if the metallic salts mentioned under a) and/or b) are selected, independently of each other, from the group consisting of acetates, acetylacetonates, 2,2′,2″-nitrilotriethanolates, propionates and/or capronates.

Particularly stable sols are produced if ethanol is used as dispersion medium.

Further advantages are produced if the at least one additive is selected from the group consisting of 2-ethoxyacetic acid, 2-(2-methoxyethoxy) acetic acid and/or triethanolamine.

Preferred concentrations of the copper(II) salt a) in the dispersion medium are between 0.01 mol/l and 5 mol/l, preferably between 0.05 mol/l and 1 mol/l, particularly preferred between 0.10 and 0.60 mol/l.

Preferred concentration ranges of the at least one salt b) in the dispersion medium are between 0.01 mol/l and 5 mol/l, preferably between 0.05 mol/l and 1 mol/l, particularly preferred between 0.10 and 0.60 mol/l.

In particular, it is advantageous if both salts a) and b) are used essentially in the same stoichiometric molar ratios, equimolar molar ratios (possibly ±10%) being specially preferred in particular.

Likewise, in a further advantageous embodiment, further additives, in addition to the components of the sol mentioned above, selected from the group consisting of Ca(II) salts, Mg(II) salts, Zn(II) salts and/or Ni(II) salts, can be contained. The additives are thereby used like the metallic salts a) and b) preferably as acetates, acetylacetonates, 2,2′,2″-nitrilotriethanolates, propionates and/or capronates.

In the case of the method, provided according to the invention, for producing a crystalline mixed oxide layer with a delafossite structure on a substrate, the substrate is wetted at least partially with a sol, as was described above, and the wetted substrate is subsequently heated.

Preferred substrates are hereby selected from the group consisting of silicon substrates, silica glass substrates or borosilicate glass substrates. The implementation of the method according to the invention hence enables firstly also substrates other than silicon to be coated via the sol-gel method.

In order to increase the delafossite layer thickness which can be applied on the substrate, an advantageous mode of implementation of the method is such that, after the wetting of the substrate, oxidation of the sol is implemented in an oxidising atmosphere and also subsequently a sintering step in an inert gas atmosphere.

Preferred temperature ranges, independently of each other, are hereby
a) for the oxidation step, between 300° C. and 550° C., preferably between 400° C. and 525° C., particularly preferred between 450° C. and 500° C. and/or
b) for the sintering step, between 550° C. and 1,200 ° C., preferably between 580° C. and 1,100° C., particularly preferred between 600° C. and 950° C.

In order to increase the layer thickness of the mixed oxide layers with a delafossite structure, deposited on the substrate, a preferred implementation of the method is such that, before step b), at least one renewed wetting of the substrate and also subsequently a renewed oxidation step a) is implemented iteratively.

According to the invention, a substrate is likewise provided, comprising a coating which covers the substrate at least partially, made of a mixed oxide of the general formula CuAO₂, A being selected from the group consisting of Al, Cr, Fe, Co, Y, La, Pr, Nd, Sm, Eu, Gd, Tb, Dy, Ho, Er, Tm and/or Yb and the mixed oxide having a delafossite structure.

The substrate can be produced preferably according to the method according to the invention described above.

Preferred layer thicknesses of the mixed oxide layer with a delafossite structure are between 10 nm and 2,000 nm, preferably between 50 nm and 1,000 nm, particularly preferred between 150 nm and 600 nm.

The above-described substrates can be used as thermoelectric material, for obtaining electrical energy from waste heat, as electrode material in electrochemical cells, as a component of catalysts for hydrogen production or nitrogen decomposition, as a component of a p-n junction, as a component of electronic components and light diodes or as luminescent material.

Furthermore, they can be used as transparent p-semiconductors, which enables the production of transparent p-n semiconductor junctions for solar cells, light diodes and further electronic components.

The present invention is explained in more detail with reference to the syntheses cited subsequently by way of example for producing the sols according to the invention and also the coating of substrates. The examples should however be understood in no way to be restrictive.

### EXAMPLE 1

15.08 g (0.061 mol) chromium(III) acetate monohydrate are dissolved at room temperature in 30.03 g (0.201 mol) triethanolamine and 114.37 g ethanol, likewise 12.18 g (0.061 mol) copper(II) acetate monohydrate in 13.97 g (0.134 mol) 2-ethoxyacetic acid and 114.37 g ethanol. Finally, the two solutions are combined. A sol which is stable over several months is obtained.

### EXAMPLE 2

14.67 g (0.073 mol) copper(II) acetate monohydrate are dissolved in 16.83 g (0.161 mol) 2-ethoxyacetic acid and 252.52 g ethanol by agitating at room temperature. After the addition of 16.01 g (0.073 mol) aluminium(III)-2,2′,2″-nitrilotriethanolate and renewed agitation at room temperature, the coating sol which is storable over several months is obtained.

### EXAMPLE 3

5.83 g (0.034 mol) iron(II) acetate and 6.69 g (0.034 mol) copper(II) acetate monohydrate are dissolved by agitating at room temperature in 19.20 g (0.184 mol) 2-ethoxyacetic acid and 47.59 g ethanol. A sol which is stable over several months is obtained.

### EXAMPLE 4

10.15 g (0.051 mol) copper(II) acetate monohydrate are dissolved at room temperature in 26.54 g (0.178 mol) triethanolamine and 200.74 g ethanol. The addition of 12.56 (0.051 mol) chromium(III) acetate monohydrate and agitation at room temperature produces the coating sol which is storable over several months.

### Production Example of the Delafossite Coating

The sols according to the invention prove to be stable over several months and can be used for dip coating. The applied thin films were firstly oxidised in air at 450° C. to 500° C. in the muffle furnace, in accordance with Ohashi et al., so that the organic components were decomposed and finally the oxides CuO and Al₂O₃ were present. These oxide layers were subjected to a second sintering step in a continuous inert gas flow (argon or nitrogen).

In order to form the delafossite, the temperature for CuAlO₂ is adjusted preferably to at least 850° C., however the formation of CuFeO₂ and CuCrO₂ began already below 600° C. For production of pure phase layers, temperatures of 900° C. or 700° C. are advantageous.

Higher layer thicknesses can be achieved by multiple coating, an oxidative furnace step being implemented after application of each individual layer. The sintering under inert gas was effected, in contrast, only once after oxidation of the last layer.

In total, a synthesis route is therefore now available, which route enables the production of different mixed oxide layers with a delafossite structure via the economical sol-gel process. By replacing the aluminium, the process temperature could be significantly reduced, which considerably extends the spectrum of useable substrates. Furthermore, the flexible sol synthesis can be used also for further delafossite systems and ternary oxides.

1. A sol, comprising a phase dispersed in at least one dispersion medium, comprising:
a) at least one Cu(III) salt,
b) at least one salt selected from the group consisting of Al(III) salts, Cr(III) salts, Fe(III) salts, Fe(III) salts, Co(II) salts, Co(III) salts, Y(III) salts, La(III) salts, Pr(III) salts, Nd(III) salts, Sm(III) salts, Eu(III) salts, Gd(III) salts, Tb(III) salts, Dy(III) salts, Ho(III) salts, Er(III) salts, Tm(III) salts and/or Yb(III) salts and
c) at least one additive selected from the group consisting of hydroxycarboxylic acids, with 2 to 12 carbon atoms, alkoxycarboxylic acids with 2 to 12 carbon atoms, alkyl alcohols with 1 to 10 carbon atoms and at least two hydroxy groups and/or organic amines,
the dispersion medium being selected from the group consisting of at least monovalent linear or branched alkyl alcohols with 1 to 6 carbon atoms.

2. The sol according to claim 1, wherein the salts a) and b) are selected, independently of each other, from the group consisting of acetates, acetylacetonates, 2,2′,2″-nitrilotriethanolates, propionates and/or capronates.

3. The sol according to claim 1, wherein the dispersion medium is ethanol.

4. The sol according to claim 1, wherein the at least one additive is selected from the group consisting of 2-ethoxyaceticacid, 2-(2-methoxyethoxy)acetic acid and/or triethanolamine.

5. The sol according to claim 1, wherein the concentration of the copper(III) salt a) in the dispersion medium is between 0.01 mol/l and 5 mol/l.

6. The sol according to claim 1, one of the preceding claims, wherein characterised in that the concentration of the at least one salt b) in the dispersion medium is between 0.01 mol/l and 5 mol/l.

7. The sol according to claim 1, wherein further additives, selected from the group consisting of Ca(II) salts, Mg(II) salts, Zn(II) salts and/or Ni(II) salts, are contained.

8. A method for producing a crystalline mixed oxide layer with a delafossite structure on a substrate in which the substrate is wetted at least partially with a sol according to claim 1 and the wetted substrate is subsequently heated.

9. The method according to claim 8, wherein the substrate is selected from the group consisting of silicon substrates, silica glass substrates or borosilicate glass substrates.

10. The method according to claim 8, comprising, after the wetting of the substrate,
a) oxidizing the sol in an oxidising atmosphere and also subsequently
b) sintering in an inert gas atmosphere.

11. The method according to claim 10, wherein
a) the oxidizing is implemented at temperatures between 300° C. and 550° C., and/or
b) the sintering step is implemented at temperatures between 550° C. and 1,200° C.

12. The method according to claim 10, comprising, before step b), at least one renewed wetting of the substrate and subsequently a renewed oxidizing step a).

13. The method according to claim 8, in which the mixed oxide is selected from compounds of the general formula CuAO₂, A being selected from the group consisting of Al, Cr, Fe, Co, Y, La, Pr, Nd, Sm, Eu, Gd, Tb, Dy, Ho, Er, Tm and/or Yb.

14. The method according to claim 8, wherein the layer thickness is between 10 nm and 2,000 nm.

15. The sol according to claim 1, wherein the concentration of the copper(II) salt a) in the dispersion medium is between 0.10 and 0.60 mol/l.

16. The sol according to claim 1, wherein the concentration of the at least one salt b) in the dispersion medium is between 0.10 and 0.60 mol/l.

17. The method according to claim 11, wherein the oxidizing is implemented at temperatures between 450° C. and 500° C.

18. The method according to claim 11, wherein the sintering is implemented at temperatures between 600 and 950° C.

19. The method according to claim 14, wherein the layer thickness is between 150 nm and 600 nm.
